(19) United States
(12) Patent Application Publication
(10) Pub. No.: US 2019/0232920 A1
(43) Pub. Date: Aug. 1, 2019

(54) MOTOR VEHICLE WIPING UNIT AND COMMAND METHOD

(71) Applicant: Valeo Systèmes d'Essuyage, Le Mesnil Saint Denis (FR)

(72) Inventors: Grégory Villemin, Le Mesnil Saint Denis (FR); Aymeric Koniec, Le Mesnil Saint Denis (FR); Benjamin Deblauwe, Le Mesnil Saint Denis (FR); Thierry Cheng, Le Mesnil Saint Denis (FR)

(73) Assignee: Valeo Systèmes d'Essuyage, Le Mesnil Saint Denis (FR)

(21) Appl. No.: 16/317,980

(22) PCT Filed: Jun. 9, 2017
(86) PCT No.: PCT/EP2017/064154

§ 371 Date: Jan. 15, 2019

(30) Foreign Application Priority Data
Jul. 18, 2016 (FR) 1656813

(51) Int. Cl. B60S 1/08; B60S 1/16

(52) U.S. Cl. CPC B60S 1/08; B60S 1/166

(57) ABSTRACT

The invention relates to a motor vehicle wiping unit (1) comprising:
at least one motor (2) configured to drive at least one windscreen wiper (5, 6) in a to-and-fro movement over a motor vehicle glass surface (11),
at least one reduction gear (3) arranged at the output of the motor (2), and
a controller (4) configured to determine a command for the motor (C),
characterized in that the controller (4) is configured to determine the command for the motor (C) by taking into account at least one variable parameter linked to the efficiency of the reduction gear (3) such as to counterbalance the variation in the efficiency of the reduction gear (3) by changing the electrical power to be provided to the motor (2).

The present invention also relates to a method for commanding the rotational speed of a motor for driving at least one windscreen wiper in a to-and-fro movement over a motor vehicle glass surface.

The present invention relates to a wiping unit and a method for commanding the instantaneous rotational speed of a motor for driving a least one windscreen wiper in a to-and-fro movement over a motor vehicle glass surface.

In a motor vehicle, the wiping device includes at least one electric motor which can move a windscreen wiper blade in order to wipe the glass surface of the vehicle.

In order for the motor to have a sufficient torque for driving the windscreen wipers in all scenarios, the electric motor is linked to a reduction gear. The reduction gear generally used in wiping devices includes at least one toothed wheel gearing with a worm rotated by the motor.

The instantaneous rotational speed of the motor determines the sweeping frequency of the windscreen wipers. In manual or automatic mode, wiping can be carried out using various sweeping frequencies, particularly to adapt the sweeping frequency to the intensity of the rain. The sweeping can thus generally be defined or chosen between intermittent sweeping, continuous sweeping with normal frequency or continuous sweeping with high frequency. The instantaneous rotational speed of the motor is then controlled in order to correspond to this frequency setpoint.

However, some factors can have an influence on the electrical power consumption of the motor and can interfere with the quality of the control. Deviations can be observed between the electrical power provided to the motor and the observed sweeping frequencies. A means is therefore sought to improve the control of the motor without however making the device too costly, particularly by avoiding the addition of feedback sensors.

To this end, the subject matter of the present invention is a motor vehicle wiping unit comprising:
at least one motor configured to drive at least one windscreen wiper in a to-and-fro movement over a motor vehicle glass surface,
at least one reduction gear arranged at the output of the motor, and
a controller configured to determine a command for the motor,

characterized in that the controller is configured to determine the command for the motor by taking into account at least one variable parameter linked to the efficiency of the reduction gear such as to counterbalance the variation in the efficiency of the reduction gear by changing the electrical power to be provided to the motor.

The controller can be configured to increase, for example in a manner proportional to the decrease in the efficiency of the reduction gear, the electrical power provided to the motor when the progression of the variable parameter tends to reduce the efficiency of the reduction gear.

The controller can be configured to decrease, for example in a manner proportional to the increase in the efficiency of the reduction gear, the electrical power provided to the motor when the progression of the variable parameter tends to increase the efficiency of the reduction gear.

By incorporating the fact that the mechanical efficiency of the reduction gear is not constant but is dependent upon various factors linked to the use of the windscreen wipers, it is possible to determine a more precise command for the motor, such that the sweeping frequency indeed corresponds to that expected, regardless of the conditions of use.

According to one or more features of the wiping unit, taken individually or in combination:
the variable parameter linked to the efficiency of the reduction gear is estimated or measured,
at least one variable parameter linked to the efficiency of the reduction gear is chosen from:
   an instantaneous rotational speed of the motor,
   a temperature of the reduction gear,
   a sweeping direction,
   a torque delivered by the motor.
the wiping unit includes a pulse-width modulator configured to be managed by the controller in order to command the motor,
the motor is configured to rotate at least one worm, the reduction gear including at least one rotating transfer member gearing with the worm.

Another subject matter of the invention is a method for commanding the instantaneous rotational speed of a motor for driving at least one windscreen wiper in a to-and-fro movement over a motor vehicle glass surface, characterized in that the command for the motor is determined by taking into account at least one variable parameter linked to the efficiency of the reduction gear arranged at the output of the motor, in order to counterbalance the variation in the efficiency of the reduction gear by changing the electrical power to be provided to the motor.

According to one or more features of the command method, taken individually or in combination:
the electrical power provided to the motor is increased, by a value determined with respect to the decrease in the efficiency of the reduction gear, when the instantaneous rotational speed of the motor decreases, and the electrical power provided to the motor is decreased, by a value determined with respect to the increase in the efficiency of the reduction gear, when the instantaneous rotational speed of the motor increases,
the electrical power provided to the motor is increased, by a value determined with respect to the decrease in the efficiency of the reduction gear, in one sweeping direction, and the electrical power provided to the motor is reduced, by a value determined with respect to the increase in the efficiency of the reduction gear, in the other sweeping direction,
the electrical power provided to the motor is increased, by a value determined with respect to the decrease in the efficiency of the reduction gear, when the temperature of the reduction gear increases, and the electrical power provided to the motor is decreased, by a value determined with respect to the increase in the efficiency of the reduction gear, when the temperature of the reduction gear decreases,
the electrical power provided to the motor is increased, by a value determined with respect to the decrease in the efficiency of the reduction gear, when the torque delivered by the motor increases, and the electrical power provided to the motor is decreased, by a value determined with respect to the increase in the efficiency of the reduction gear, when the torque delivered by the motor decreases.

The following description with reference to the appended drawings, given as nonlimiting examples, will explain the features of the invention and how it can be produced.

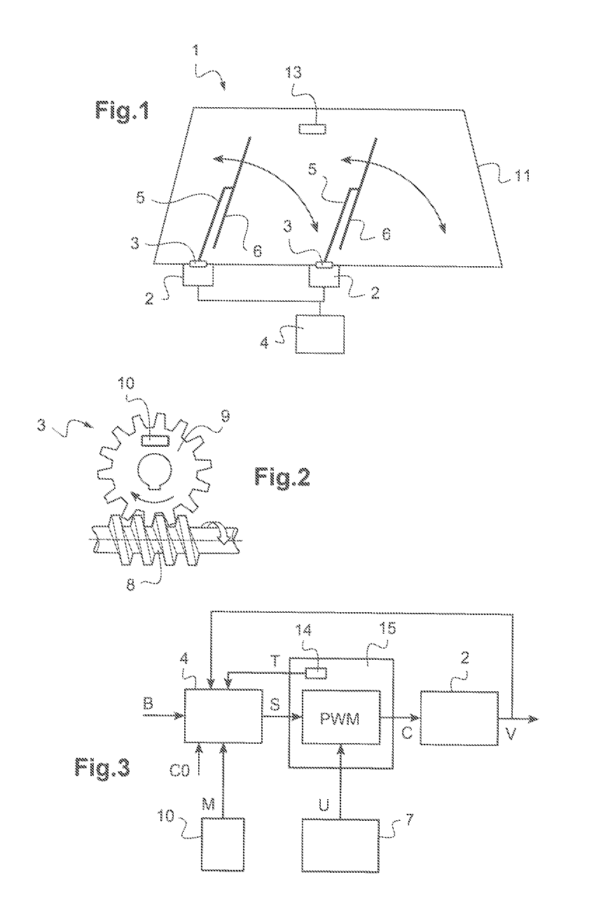

FIG. 1 is a schematic view showing a motor vehicle glass surface and a wiping unit of the vehicle.

FIG. 2 shows a reduction gear example for the wiping unit of FIG. 1.

FIG. 3 shows a schematic view of elements of the wiping unit of FIG. 1.

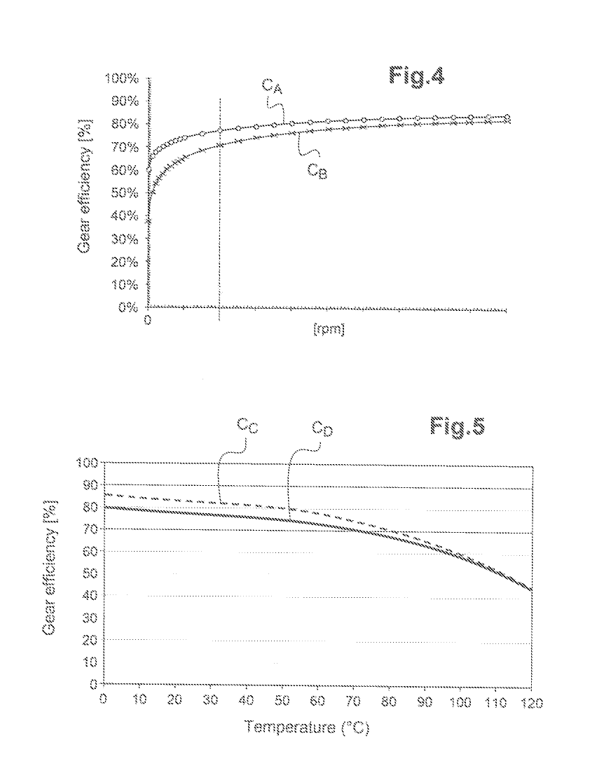

FIG. 4 shows an illustrative graph having, in the X-axis, the instantaneous rotational speed of the motor of the wiping unit (in RPM) and, in the Y-axis, the efficiency (in %) of the reduction gear of the wiping unit. The graph includes two curves, one curve C_{A} (circles) showing the efficiency of the reduction gear in one sweeping direction, for example downward, and a curve C_{B} (crosses) showing the efficiency of the reduction gear in the other direction, for example upward.

FIG. 5 shows an illustrative graph having, in the X-axis, the temperature of the reduction gear and, in the Y-axis, the efficiency (in %) of the reduction gear. The graph includes two curves, one curve C_{c} (broken line) showing the efficiency of the reduction gear in one sweeping direction and a curve C_{d} (solid line) showing the efficiency of the reduction gear in the other direction.

In the remainder of the description, identical or similar elements will be designated by the same reference numbers.

The following embodiments are examples. Although the description makes reference to one or more embodiments, this does not necessarily mean that each reference relates to the same embodiment, or that the features apply only to a single embodiment. Individual features of various embodiments can also be combined or switched in order to provide other embodiments.

FIG. 1 shows a motor vehicle wiping unit 1.

The wiping unit 1 includes at least one motor 2, at least one reduction gear 3 arranged at the output of the motor 2 and a controller 4.

The motor 2 is configured to drive at least one windscreen wiper 5, 6 in a to-and-fro movement over the glass surface 11 of the vehicle. The to-and-fro movement is made up of alternate downward and upward movements. The downward direction corresponds to the movement of the windscreen wipers 5, 6 from the top to the bottom, and the upward direction corresponds to the movement of the windscreen wipers 5, 6 from the bottom to the top.

The wiping unit 1 includes, for example, two motors 2 associated with the front glass surface 11 of the vehicle (windscreen), a motor 2 driving each drive arm 5, each drive arm 5 driving a windscreen wiper blade 6.

The direct current motor 2 conventionally comprises a stator and a rotor. According to an exemplary embodiment shown in FIG. 2, the shaft of the rotor bears at least one worm 8, for example made of metal.

The reduction gear 3 includes a gear transmission including at least one rotating transfer member 9 inserted between the worm 8 and an output shaft, gearing with the worm 8.

The rotating transfer member 9 includes, for example, a toothed wheel or sector, for example made of metal or plastic.

The output shaft is, for example, coaxial with the rotating transfer member 9 and constrained to rotate with the rotating transfer member 9. The output shaft is intended to be assembled with a windscreen wiper element to be rotated, such as a crank (or lever) of a transmission device of a windscreen wiper mechanism or such as a drive arm head.

The controller 4 is configured to control the instantaneous rotational speed of the motor V on the basis of a command for the motor C particularly determined as a function of a sweeping frequency setpoint B in order to change the sweeping frequency of the at least one windscreen wiper 5, 6.

The controller 4 includes one more microcontrollers or computers, having memories and programs suitable for carrying out calculations, receiving and giving instructions to the elements to which it is linked. This is, for example, the on-board computer of the motor vehicle.

The sweeping frequency setpoint B can be controlled by the driver by means of a lever or any form of actuator in the passenger compartment, most often close to the steering wheel or on the dashboard.

In manual mode, the user can, for example, choose between several sweeping frequency setpoints B comprising the stop position in which the windscreen wipers 5, 6 are deactivated, a single sweep, intermittent sweeping comprising a number of sweeps per unit of time defined by the user, for example by means of a thumbwheel arranged on the lever, continuous sweeping with normal frequency and continuous sweeping with high frequency.

Some vehicles are, moreover, fitted with a rain sensor 13 for determining if it rains and the intensity of the rain. In this case, the user can also select an automatic mode in which the sweeping frequency setpoint. B is selected from the stop position, continuous sweeping with normal frequency or continuous sweeping with high frequency dependent upon the processing of the information provided by the rain sensor 13.

To modulate the instantaneous rotational speed of the motor V, for example between 0 and 100 RPM, the wiping unit 1 can include a pulse-width modulator PWM configured to provide a command for the motor C by modulating the duration of a succession of pulses, using a voltage U of the power supply 7 and a command signal S.

In addition to the sweeping frequency setpoint B, the controller 4 is configured to determine the command for the motor C for controlling the instantaneous rotational speed of the motor V also as a function of a least one variable parameter linked to the efficiency of the reduction gear 3 such as to counterbalance the variation in the efficiency of the reduction gear 3 by changing the electrical power to be provided to the motor 2.

The modification of the electrical power can be an increase or a decrease, which can be optionally proportional to the variation in efficiency of the reduction gear 3, which can be continuous or discrete (in steps) and can be determined using predefined tables, wherein the predefined values can be dependent upon the features of the wiping unit 1.

The controller 4 can be configured to increase, for example in a manner proportional to the decrease in the efficiency of the reduction gear 3, the electric power provided to the motor 2 when the progression of the variable parameter tends to reduce the efficiency of the reduction gear 3, and to decrease, for example in a manner proportional to the increase in the efficiency of the reduction gear 3, the electric power provided to the motor 2 when the progression of the variable parameter tends to increase the efficiency of the reduction gear 3.

Indeed, it is considered that the efficiency of the reduction gear 3, which efficiency is defined by the ratio between the mechanical power provided to the windscreen wipers 5, 6 and the electrical power provided to the motor 2, is not constant but varies depending upon the conditions of use, and that this variability must be taken into account in order to determine the command for the motor C.

For this purpose, it is possible to compare the efficiency at an instant t with the value of the efficiency at a previous instant t−1. Depending on the result of this comparison, the electrical power provided to the motor 2 is increased or decreased.

The variable parameter linked to the efficiency of the reduction gear 3 can be estimated or measured.

In the case of estimated variable parameters, the controller 4 can include, in memory, tables and/or laws for associating an electrical power to be provided to the motor 2 as a function of the efficiency of the reduction gear 3.

The variable parameter that can vary the efficiency of the reduction gear 3 can be:
an instantaneous rotational speed of the motor V,
a temperature T of the reduction gear 3,
the sweeping direction M,
a torque delivered by the motor C0.

The sweeping frequency setpoint B can influence the efficiency of the reduction gear 3.

Indeed, the instantaneous rotational speed of the motor V is dependent upon the sweeping frequency. Yet, the instantaneous speed of the motor can influence the efficiency of the reduction gear 3. Thus, the efficiency of the reduction gear 3 is better when the instantaneous speed increases. An example is, thus, illustrated in FIG. 4.

FIG. 4 shows two curves C_{A} and C_{B} for efficiency of the reduction gear 3 as a function of the instantaneous speed in RPM. The curve C_{A} (circles) shows the efficiency of the reduction gear 3 in one sweeping direction and the curve C_{B} (crosses) shows the efficiency of the reduction gear 3 in the other direction. It is noted on this figure that, for the two curves C_{A} and C_{B}, the more the instantaneous speed increases, the more the efficiency of the reduction gear 3 increases. This difference is not proportional to the increase in the instantaneous speed. The effects of the speed on the efficiency of the reduction gear 3 are greater at low speed (towards the starting point 0) and in one direction, for example upward (curve C_{B}). Indeed, in this example, in the upward direction, the efficiency of the reduction gear 3 can vary between 1% and 50% for an instantaneous speed varying between an almost zero value and the maximum speed. Thus, the more the instantaneous speed increases, the less there will be losses in the electrical power provided to the motor 2.

Therefore, it is possible to increase, by a value determined with respect to the decrease in the efficiency of the reduction gear 3, the electrical power provided to the motor 2 when the instantaneous rotational speed of the motor V decreases and to decrease, by a value determined with respect to the increase in the efficiency of the reduction gear 3, the electrical power provided to the motor 2 when the instantaneous rotational speed of the motor V increases.

The instantaneous rotational speed of the motor V can be obtained by means of an angular position sensor.

The tables and/or laws stored in memory allow for determining the increase in electrical power to be taken into account due to the fall in efficiency of the reduction gear 3 for low speeds, in addition to the electrical power to be provided in order to reach a sweeping frequency setpoint B.

The sweeping direction can also influence the efficiency of the reduction gear 3.

This difference in efficiency can be explained by the orientation of the teeth of the rotating transfer member 9 of the reduction gear 3 which can lead to greater losses through mechanical friction between the reduction gear 3 and the worm 8 in one direction compared to the other. The orientation of the teeth is determined by the direction of mounting the reduction gear 3 in the vehicle.

An example is shown in FIG. 4. The curve C_{A} (circles) shows the efficiency of the reduction gear 3 in one direction, for example downward, and the curve C_{B} (crosses) shows the efficiency of the reduction gear 3 in the other direction. It is noted, in this figure, that for a same instantaneous rotational speed of the motor (broken vertical line), the efficiency of the reduction gear 3 is less in one direction than in the other. A variation between 5% and 25% in the efficiency of the reduction gear 3 can be observed. This variation is not proportional to the increase in the speed but decreases with the increase in the instantaneous speed of the motor 2.

Therefore, it is possible to increase, by a value determined with respect to the decrease in the efficiency of the reduction gear 3, the electrical power provided to the motor 2 in one sweeping direction M, and to reduce, by a value determined with respect to the increase in the efficiency of the reduction gear 3, the electrical power provided to the motor 2 in the other sweeping direction M. The difference in power between the two directions can be all the greater since the instantaneous speed is low.

The information for the sweeping direction M can already be available via the controller 4 for managing the sweeping movement of the blades 5, 6. This can be determined by an angular position sensor 10 for the windscreen wiper 5, 6. Thus, in addition to making it possible to manage alternating sweeping, the information provided by the angular position sensor 10 can also allow for the control of the electrical power to be provided to the motor 2.

The increase in electrical power to be taken into account due to the fall in efficiency of the reduction gear 3 in one direction compared to the other direction can be determined from tables and/or laws stored in memory.

The temperature T of the reduction gear 3 can also influence the efficiency of the reduction gear 3.

Due to the nature of the material thereof, particularly plastic, the rotating transfer member 9 can be more or less rigid depending upon the temperature. As can be noted in FIG. 5, the fall in temperature of the reduction gear 3 tends to increase the efficiency of the reduction gear. Indeed, the hot teeth of a reduction gear 3 tend to absorb the force by deforming, which impacts upon the efficiency performance of the reduction gear 3.

In a motor vehicle, the temperature of the reduction gear 3 can be measured between −40° C. and +115° C. In order to compensate for the fall in efficiency of the reduction gear 3 with the increase in the temperature, it is therefore possible to increase, by a value determined with respect to the decrease in the efficiency of the reduction gear 3, the electrical power provided to the motor 2 when the temperature of the reduction gear 3 increases, and to decrease, by a value determined with respect to the increase in the efficiency of the reduction gear 3, the electrical power provided to the motor 2 when the temperature of the reduction gear 3 decreases.

The influence on the temperature is greater when the rotating transfer member 9 of the reduction gear 3 and the worm 8 have different constituent materials, and more particularly when the rotating transfer member 9 is made from plastic and the worm 8 is made from metal.

The temperature T of the reduction gear 3 can be estimated, for example using a mathematical model and using measurements provided by a temperature sensor 14 of the electronic board 15 bearing, in particular, the pulse-width modulator PWM, particularly arranged close to the reduction gear 3.

The torque delivered by the motor C0 can also influence the efficiency of the reduction gear 3. Indeed, the more the torque delivered to the motor C0 increases, the more the efficiency of the reduction gear 3 decreases.

In order to compensate for the fall in efficiency of the reduction gear 3 with the increase in the torque C0, it is possible to increase, by a value determined with respect to the decrease in the efficiency of the reduction gear 3, the electrical power provided to the motor 2 when the torque C0 increases, and to decrease, by a value determined with respect to the increase in the efficiency of the reduction gear 3, the electrical power provided to the motor 2 when the torque C0 decreases.

The information on the value of the torque delivered by the motor can be estimated, for example using a mathematical model or predefined tables.

Thus, by incorporating the fact that the mechanical efficiency of the reduction gear 3 is not constant but is dependent upon various factors linked to the use of the windscreen wipers 5, 6, it is possible to determine a more precise command for the motor C, such that the sweeping frequency indeed corresponds to that expected, regardless of the conditions of use.

1. A motor vehicle wiping unit comprising:
at least one motor configured to drive at least one windscreen wiper in a to-and-fro movement over a motor vehicle glass surface;
at least one reduction gear arranged at the output of the motor; and
a controller configured to determine a command for the motor,
wherein the controller is configured to determine the command for the motor by taking into account at least one variable parameter linked to the efficiency of the reduction gear such as to counterbalance the variation in the efficiency of the reduction gear by changing the electrical power to be provided to the motor.

2. The wiping unit according to claim 1, wherein the controller is configured to increase the electrical power provided to the motor when the progression of variable parameter tends to reduce the efficiency of the reduction gear.

3. The wiping unit according to claim 1, wherein the controller is configured to decrease the electrical power provided to the motor when the progression of the variable parameter tends to increase the efficiency of the reduction gear.

4. The wiping unit according to claim 1, wherein the variable parameter linked to the efficiency of the reduction gear is estimated or measured.

5. The wiping unit according to claim 1, wherein at least one variable parameter linked to the efficiency of the reduction gear is chosen from:
an instantaneous rotational speed of the motor,
a temperature of the reduction gear,
a sweeping direction,
a torque delivered by the motor.

6. The wiping unit according to claim 1, further comprising a pulse-width modulator (PWM) configured to be managed by the controller to command the motor.

7. The wiping unit according to claim 1, wherein the motor is configured to rotate at least one worm, the reduction gear including at least one rotating transfer member gearing with the worm.

8. A method for commanding the instantaneous rotational speed of a motor for driving at least one windscreen wiper in a to-and-fro movement over a motor vehicle glass surface, the method comprising:
determining the command for the motor by taking into account at least one variable parameter linked to the efficiency of the reduction gear arranged at the output of the motor, in order to counterbalance the variation in the efficiency of the reduction gear by changing the electrical power to be provided to the motor.

9. The command method according to claim 8, further comprising:
increasing the electrical power provided to the motor, by a value determined with respect to the decrease in the efficiency of the reduction gear, when the instantaneous rotational speed of the motor decreases; and
decreasing the electrical power provided to the motor, by a value determined with respect to the increase in the efficiency of the reduction gear, when the instantaneous rotational speed of the motor increases.

10. The command method according to claim 8, further comprising:
increasing the electrical power provided to the motor, by a value determined with respect to the decrease in the efficiency of the reduction gear, in one sweeping direction; and
reducing the electrical power provided to the motor, by a value determined with respect to the increase in the efficiency of the reduction gear, in the other sweeping direction.

11. The command method according to claim 8, further comprising:
increasing the electrical power provided to the motor, by a value determined with respect to the decrease in the efficiency of the reduction gear, when the temperature of the reduction gear increases; and
decreasing the electrical power provided to the motor, by a value determined with respect to the increase in the efficiency of the reduction gear, when the temperature of the reduction gear decreases.

12. The command method according to claim 8, further comprising:
increasing the electrical power provided to the motor, by a value determined with respect to the decrease in the efficiency of the reduction gear, when the torque delivered by the motor increases; and
decreasing the electrical power provided to the motor, by a value determined with respect to the increase in the efficiency of the reduction gear, when the torque delivered by the motor decreases.
